(19) United States
(12) Patent Application Publication
(10) Pub. No.: US 2026/0171271 A1
(43) Pub. Date: Jun. 18, 2026

(54) SYSTEMS AND METHODS FOR ADDITIVELY MANUFACTURED TARGETS FOR INERTIAL CONFINEMENT FUSION

(71) Applicant: Lawrence Livermore National Security, LLC, Livermore, CA (US)

(72) Inventors: Widianto Putra MOESTOPO, San Leandro, CA (US); Xiaoxing Xia, Pleasanton, CA (US); Gregory Elijah Kemp, Tracy, CA (US)

(73) Assignee: Lawrence Livermore National Security, LLC, Livermore, CA (US)

(21) Appl. No.: 18/981,299

(22) Filed: Dec. 13, 2024

(51) Int. Cl. G21B 1/19; B33Y 80/00; G21C 21/02

(52) U.S. Cl. CPC G21B 1/19; B33Y 80/00; G21C 21/02

(57) ABSTRACT

The present disclosure relates to a target capsule apparatus for holding a fuel. In some embodiments the target capsule may be used to hold a fuel used in an inertial confinement fusion power plant. In one embodiment the apparatus may have an additively manufactured outer shell having an inner surface, and an interior area of the outer shell forms a volume adapted to contain the fuel. The inner surface may have a varying density which decreases in a radially inward direction towards an axial center of the outer shell.

### FEDERALLY SPONSORED RESEARCH OR DEVELOPMENT

This invention was made with Government support under Contract No. DE-AC52-07NA27344 awarded by the United States Department of Energy. The Government has certain rights in the invention.

### FIELD

The present disclosure relates to the manufacture of target capsules for use in holding a substance, and more particularly to a target capsule having a solid shell with an engineered interior layer which are additively manufactured together, along with any attachment that is necessary for use of the target capsule in a selected application.

### BACKGROUND

The statements in this section merely provide background information related to the present disclosure and may not constitute prior art.

Recent groundbreaking experiments that showed the first instances that fusion ignition (i.e., more energy generated via fusion reaction compared to the laser energy driven onto the target) can be achieved in a laboratory setting relied on an indirect drive target design. This is where the laser system is not aimed directly on the fusion fuel-containing capsule in the middle of the target but is instead directed on the inner layer of the hohlraum outside of the capsule to produce an optimized X-ray bath on the capsule. Current target designs for ignition also still demand a deuterium-tritium (D-T) ice layer to be formed on the inner layer of the capsule—a complex process that can take multiple days.

Researchers speculate that a capsule that can hold a layer of liquid fuel on its inner surface would simplify target fabrication and allow the exploration of more complex phenomena, including higher ignition energy yield. A fuel target capsule with a porous foam layer attached to the inner surface of the capsule was disclosed in LLNL U.S. Patent Publication No. US 2013/0308736A1 to Kucheyev, published Nov. 21, 2013, and assigned to the assignee of the present disclosure, the teachings of which are hereby incorporated by reference into the present disclosure. Moreover, an asymmetric capsule design has also been developed in LLNL to allow for different laser-target interactions, which is disclosed in US Patent Publication No. 2020/0327998A1 to Peterson et al, published Oct. 15, 2020, and assigned to the assignee of the present disclosure, the teachings of which are hereby incorporated by reference into the present disclosure.

Additive manufacturing (AM) techniques, in particular two-photon lithography (TPL), have been proposed to fabricate targets that would otherwise be impossible to manufacture using conventional means. TPL uses an optical objective to focus a femtosecond laser beam into a voxel inside a volume of photoresist. The photoresist is sensitive to light with a wavelength of approximately half of the laser beam wavelength. TPL has been used to fabricate low density (e.g., down to 5 mg/cm³ ) and low atomic-number (CHO) polymeric foams for potential targets, and some have been tested at the OMEGA Laser Facility at the University of Rochester. TPL has also been used to fabricate a full capsule with diameter of ˜4.7 mm or less, and a capsule with an attached foam layer outside of the solid shell.

### SUMMARY

This section provides a general summary of the disclosure, and is not a comprehensive disclosure of its full scope or all of its features.

In one aspect the present disclosure relates to a target capsule apparatus for holding a fusion fuel. The apparatus may comprise an additively manufactured outer shell having an inner surface and an interior area of the outer shell forming volume adapted to contain the fuel. The inner surface of the outer shell may have a varying density which decreases in a radially inward direction towards an axial center of the outer shell.

In another aspect the present disclosure relates to a target capsule apparatus for holding a fuel. The apparatus may comprise an additively manufactured outer shell having an inner surface and an interior area of the outer shell forming volume adapted to contain the fuel. The outer shell may further include an opening formed therein. A tubular portion may be included which projects outwardly from the outer shell and communicates with the interior volume of the outer shell, and which is integrally formed with the outer shell.

In still another aspect the present disclosure relates to a method for forming a target capsule apparatus for holding a fuel. The method may comprise additively manufacturing an outer shell having an inner surface, with an interior area of the outer shell forming volume adapted to contain the fuel. The method may further include additively manufacturing a neck portion integrally formed with the outer shell. The inner surface of the outer shell may be formed as an engineered inner surface.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

Corresponding reference numerals indicate corresponding parts throughout the several views of the drawings.

FIG. 1 is a side view of an AM manufactured target capsule in accordance with one embodiment of the present disclosure;

FIG. 2 is a side cross-sectional view of the target capsule shown in FIG. 1 taken along section line 2-2

FIG. 3 is a perspective view of one half of the target capsule shown in FIG. 2;

FIG. 4 is an image of one half of a single piece, AM manufactured target capsule having a solid outer layer and an inner foam layer, in accordance with another embodiment of the present disclosure;

FIG. 5 is an image of one half of a single piece, AM manufactured target capsule having a solid outer layer and an inner layer of a beam lattice foam, in accordance with another embodiment of the present disclosure;

FIG. 6 is an image of one half of a single piece, AM manufactured target capsule having a solid outer layer and an inside surface coated with a metallic material layer, in accordance with another embodiment of the present disclosure;

FIG. 7 is a side view of another embodiment of the present disclosure showing an AM manufactured target capsule having a spherical portion with a neck portion forming a cone which is secured to the sphere portion, and where the cone has a portion which projects into an interior area of the sphere to a point near an axial center of the spherical portion;

FIG. 8 is a side cross-sectional view of the target capsule of FIG. 7 taken in accordance with section line 8-8 in FIG. 7 showing the interior of the spherical portion and the cone secured thereto;

FIG. 9 a side view of an AM printed target capsule in accordance with another embodiment of the present disclosure where the target capsule includes an enlarged base and a removable fill tube;

FIG. 10 is a side cross-sectional view of the target capsule of FIG. 9 taken in accordance with section line 10-10 in FIG. 9, showing more clearly the interior areas of the spherical portion, base and neck portion of the target capsule;

FIG. 11 is a perspective view of a portion of a target capsule in accordance with another embodiment of the present disclosure wherein an inside surface of the solid outer surface includes a gyroid/shell material layer;

FIG. 12 a highly enlarged illustration of a portion of the target capsule of FIG. 11;

FIG. 13 is cross-sectional side view of an AM manufactured target capsule in accordance with another embodiment of the present disclosure where an inside surface of a solid outer shell has a lattice like, beam-based material layer design;

FIG. 14 is a highly enlarged illustration of a portion of the target capsule of FIG. 13 showing more clearly the lattice-like, beam-based material layer design;

FIG. 15 is a side view of another embodiment of the present disclosure showing an AM manufactured target capsule having an asymmetric capsule design;

FIG. 16 is a side cross-sectional view of the target capsule of FIG. 15 taken in accordance with section line 16-16 in FIG. 15 better illustrating the interior construction of the target capsule;

FIG. 17 is a side view of another embodiment of the present disclosure showing an AM manufactured target capsule where a spherical portion of the target capsule is AM printed directly on a fill tube to form a unitary structure; and

FIG. 18 is a side cross-sectional view of the target capsule of FIG. 17 taken in accordance with section line 18-18 in FIG. 17 better illustrating the interior construction of the target capsule.

### DETAILED DESCRIPTION

Example embodiments will now be described more fully with reference to the accompanying drawings.

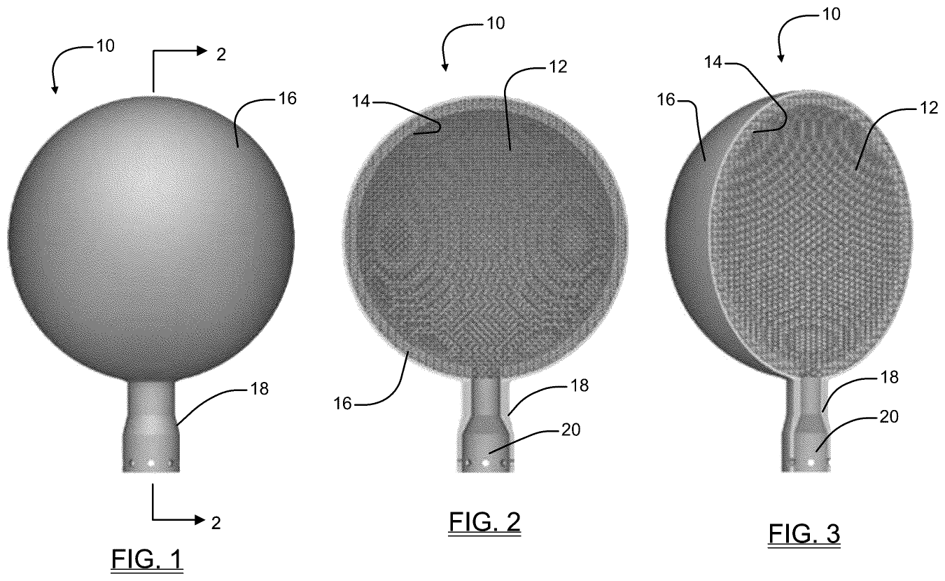

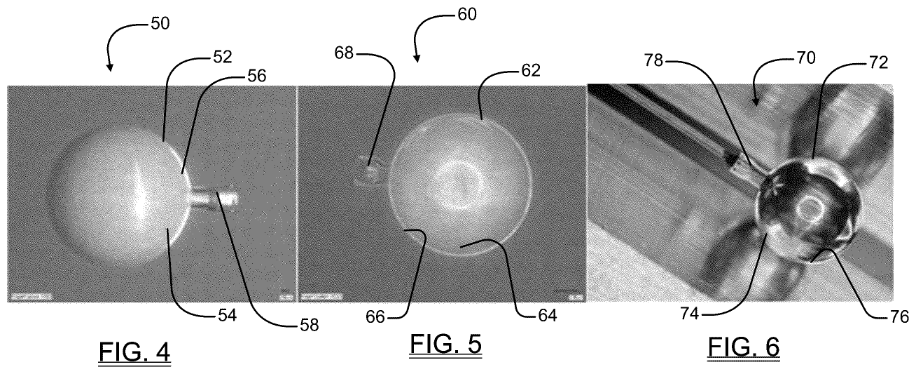

The present disclosure describes new capsule target designs and methods of manufacture therefore, where a solid shell and a foam layer is additively manufactured together along with any attachment that is necessary for its application. Referring to FIGS. 1-3, a new capsule 10 is shown in accordance with embodiment of the present disclosure. The new capsule 10 in this example includes an engineered inner surface layer which in form implementation may be a foam inner layer 12. The foam inner layer 12 is integrally formed with the inner surface 14 of a spherically shaped, outer solid shell 16. In some embodiments the solid shell 16 includes an integrally formed neck portion 18. The neck portion 18 in this example is tubular to form an interior channel 20, as visible in FIGS. 2 and 3. Since the neck portion 18 is additively manufactured together with the rest of the capsule 10, the capsule forms a unitary structure. The neck portion 18 can act as an insertion guide for a fuel fill tube, and/or a barrier to prevent a fill tube from being inserted into the capsule cavity enclosed by the solid shell 12 and inner surface 14, and/or as a handle to position the capsule target 10 without touching and damaging the capsule shell 16, and/or as a stable base for the rest of the capsule solid shell 16 to be printed on during a layer-by-layer additive manufacturing process. Such processes may include, but are not limited to, two photon lithography (TPL), stereolithography (SLA), digital light processing (DLP), volumetric additive manufacturing (VAM), selective laser sintering (SLS).

It will be appreciated that the combination of the thickness of the solid outer shell 16, the thickness of the foam inner layer 12, as well as the densities of these two structural portions of the target capsule 10 are highly important, and interdependent factors, in imparting the needed structural integrity to the target capsule which prevents it from collapsing as it is being filled or during its use. This has been an issue with prior target capsule designs which were AM manufactured. With the target capsule 10, it is believed that in practice, a thickness of between 5 μm-30 μm for the solid outer shell 16, and a thickness of between about 50 μm-150 μm for the foam layer 12, cooperatively provide the necessary structural integrity to prevent the target capsule 10 from collapsing during filling or use. The density of the solid outer shell 16 is also preferably between about 1100 mg/cc-1500 mg/cc, while the density of the foam layer 12 is preferably about 50 mg/cc-250 mg/cc. Depending on the specific design of the structure formed on the inner layer 14 of the outer shell 16 (i.e., either foam, gyroid, beam-like lattice, etc.), the density may vary, but in most instances the density of the inner material layer (i.e., the layer formed on the inside surface layer 14 of the solid outer shell 16), will typically be between about 10 mg/cc-70 mg/cc. Furthermore, in some embodiments the density of the inner layer 14 may decrease in a direction radially inward towards an axial center of the outer shell 16. In some embodiments the decrease in density moving radially inwardly towards an axial center of the outer shell 16 may vary linearly, and in some embodiments the decrease may be non-linearly. In some embodiments the density of the inner layer 14 may instead increase radially inwardly as one moves towards an axial center of the outer shell 16.

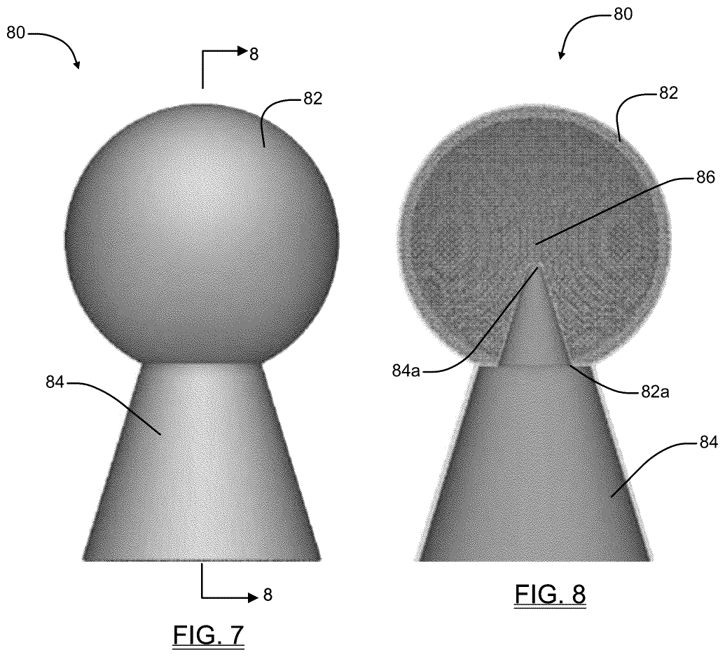

FIGS. 4, 5 and 6 are cross-sectional images of AM fabricated capsules based largely on the single piece construction design shown in FIGS. 1-3. FIG. 4 shows a capsule 50 having a solid outer shell 52 with an engineered inner surface represented by integrally formed gyroid (shell lattice) 54 on an inside surface 56 of the shell, and an integrally formed tubular neck portion 58. FIG. 5 shows a capsule 60 with a solid outer shell 62, a lattice beam foam layer 64 on an inside surface 66 of the shell, and an integrally formed, tubular neck portion 68. FIG. 6 shows a capsule 70 with a solid outer shell 72 coated with an outer metal coating layer 74, an inside surface 76 of the shell 72, and an integrally formed, tubular neck portion 78.

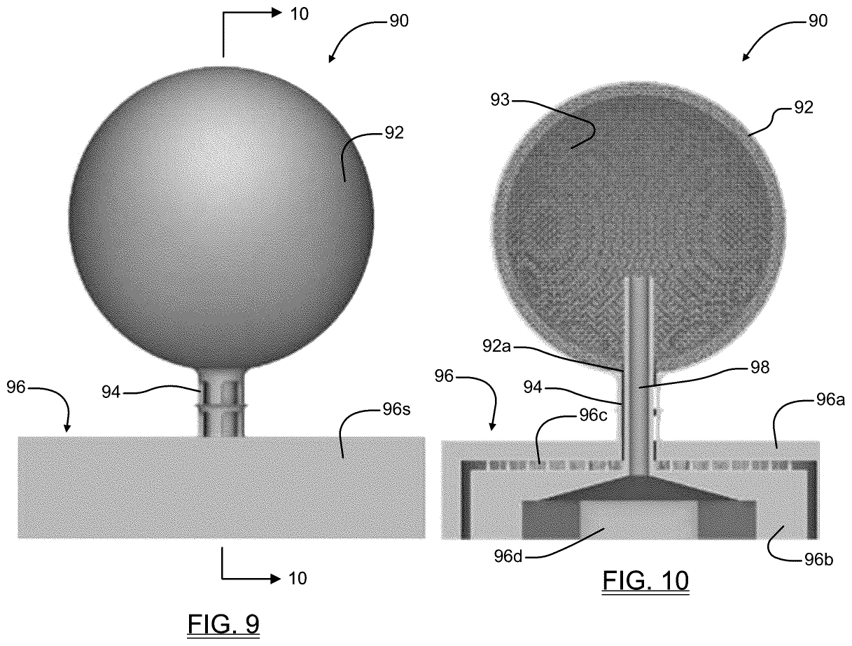

Referring to FIGS. 7 and 8, an AM formed target capsule 80 is shown in accordance with another embodiment of the present disclosure. The target capsule 80 in this example includes an integrally formed outer shell 82, but instead of an integrally formed fill tube attachment feature, the target capsule has a tubular or hollow cone 84 attached to the outer shell 82 at a circular opening 82a of the shell. The cone 84 tip 84a can be manufactured such that it extends at varying distances from the capsule 80 axial center 86, as indicated in FIG. 8. The cone 84 can be secured to the shell 82, for example and without limitation, by gas-tight and liquid-tight adhesives. The cone 84 can act as a source for X-ray, neutron, electron, or proton in a high energy density (HED)/fusion experiment, as well as a laser target in a fast-ignition experiment. The target capsule may also incorporate any one of the engineered surface layers described above, and such a layer may be integrally formed with an inner surface of the outer shell 82. Still further, the outer shell 82, the hollow cone 84, and any engineered surface layer could be printed as a single unitary structure, or the outer shell 82 could be printed directly on the hollow cone 84.

To assist with cleaning excess material/photoresist and/or filling the AM target shell, a detachable cleaning and filling tube can be fabricated together with the AM target, as shown for the target capsule 90 in FIGS. 9 and 10. In this new embodiment, the AM formed target shell 90 has a solid spherically shaped outer shell 92 with an engineered inner surface layer formed by an inner layer of foam 93. The outer shell 92 has a circular opening 92a and a tubular portion 94 which extends to an enlarged base 96. The enlarged base 96 has an upper section 96a and a lower section 96b secured to the upper section by a plurality of physical links or struts 96c, which can be broken when the lower section 96b is rotated relative to the upper section 96a. The lower section 96b also has an open interior area 96d which communicates with a filling tube 98. The filling tube 98 extends into an interior area of the outer shell 92 and can be used to help fill the target capsule 90. The filling tube 98 is removable when the lower section 96b is rotated relative to the upper section 96a, which enables easy removal of the filling tube 98 and cleaning thereof.

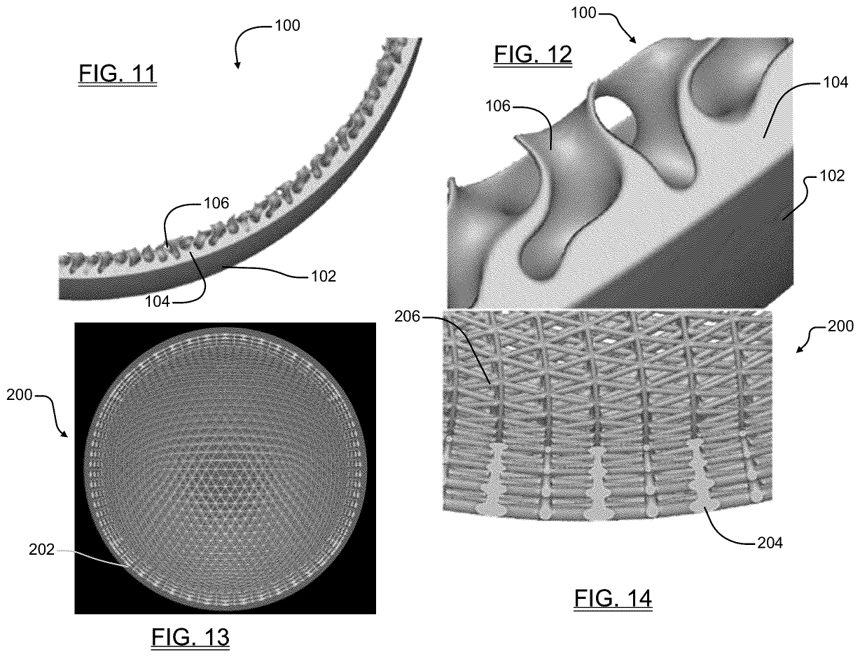

The additively manufactured foam that is fabricated together with the solid shell in the above-described embodiments can have varying geometries and is not limited to just one topology and density. For example, in some embodiments, such as shown in FIGS. 11 and 12, a target capsule 100 is illustrated which may have a solid outer shell 102 with an inner surface 104 having an engineered surface formed by a shell-based (e.g., gyroid) foam layer 106, which is integrally formed with the inner surface 104. In some embodiments, such as shown in FIGS. 13 and 14, a target capsule 200 is shown which may have a solid outer shell 202 with an inside surface 204 having an engineered surface forming a beam-based foam layer 206. In both target capsules 100 and 200, the density of the interior shell-based foam layer 106 or beam-based foam layer 206 may vary throughout the foam lining portion 106 or 206. The local density of the foam 106 or 206 can be prescribed by changing various parameters, for example and without limitation, the design parameters of the foam, including the designed ligament/shell thickness at a given location, the distance between neighboring ligaments/shells, and the foam topology itself (e.g., shell-based, beam-based, plate-based, etc.).

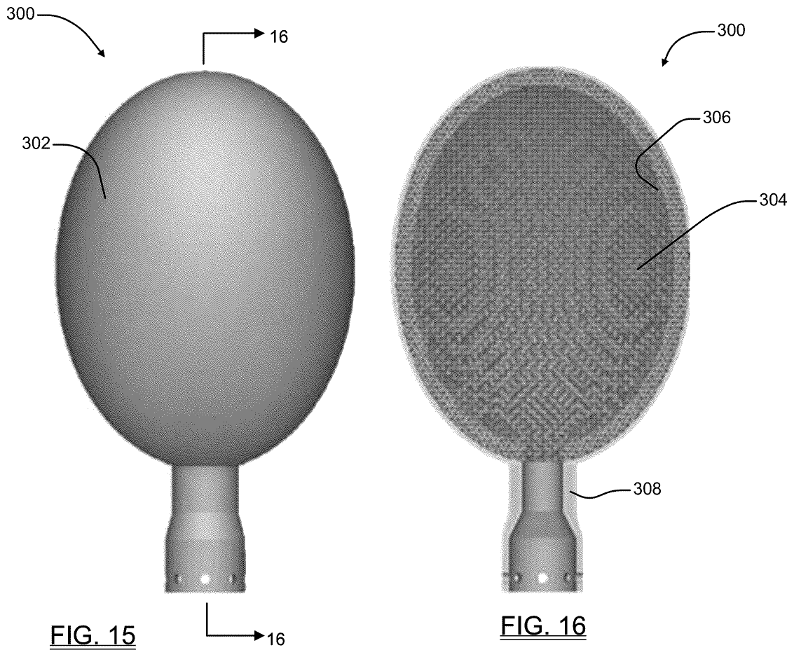

Moreover, the AM target capsule construction is not limited to a spherical capsule but may instead be of one or more differing asymmetric designs. This is illustrated in FIGS. 15 and 16, which show an AM formed target capsule 300 in accordance with another embodiment of the present disclosure. In this example the target capsule 300 which is egg-shaped or oblong-shaped. The target capsule 300 has a solid outer shell 302 with a layer of foam 304 formed on an inner surface 306 of the shell 302. A tubular neck portion 308 is integrally formed with the shell 302. The non-spherical configurations of the solid outer shell may also incorporate one of the integrally formed, engineered surfaces as described hereinabove.

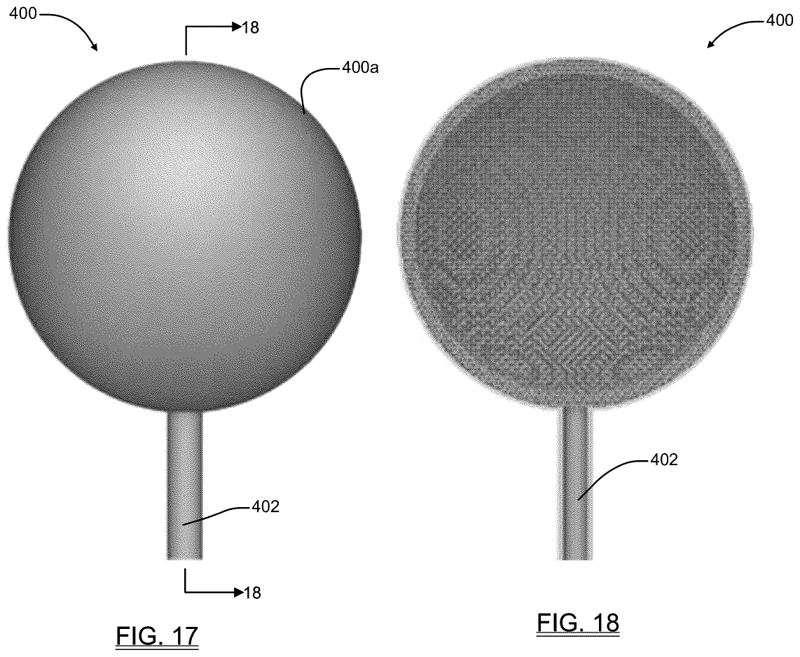

FIGS. 17 and 18 show still another embodiment of the present disclosure where an AM formed target capsule 400 has an outer shell 400a which is directly fabricated on a tubular fill tube portion 402, as shown in FIG. 17. The fill tube 402 can be sealed even further to the outer shell 400a using suitable gas-tight and liquid-tight adhesives. The overall target manufacturing process can include a robotic arm and/or a hexapod robot to assist with handling the capsule during fabrication and assembly. Any one of the engineered inner surfaces described above could also be implemented in the target capsule 400.

It will also be appreciated that with any of the above described embodiments, two or more portions of the target capsule may be additively manufactured using two or more distinct materials. As such, the entire structure may form an integrally formed, unitary structure, but with different portions thereof being made from different materials. For example, the solid outer shell 16 of the target capsule 10 (FIGS. 1-3) may be formed from one material, while the engineered inner surface layer 12 and the neck portion 18 are formed from a different material in a single AM printing operation. Also, in each of the hereinbefore discussed embodiments, the outer shell may be spherically shaped or asymmetrically shaped. Still further, in each of the foregoing embodiments, an engineered inner surface layer (i.e., a non-smooth layer, for example and without limitation, a gyroid-like layer, a foam layer, a lattice beam-like layer, a combination of multiple foam topologies, etc.) may be formed on the inner surface of the outer shell.

In some embodiments the wherein the engineered inner surface of the outer shell may be comprised of at least one of a membrane-based structure, or a shell-based structure, or a plate-based structure, or possibly a combination of such structure. If the inner surface of the shell comprises a lattice beam-like structure, then the lattice beam-like structure may have at least one of a periodic construction or a stochastic (i.e., random) construction. In some embodiments the lattice beam-like structure may even form a combination of periodic and stochastic portions.

For each of the embodiments described herein, the inner surface layer of the outer shell may vary in density moving radially inwardly towards an axial center of the outer shell 16, 52, 62, 72, 82, 92, 102, 202, 302, and 400a, the variation may be increasing or decreasing as one moves radially inwardly towards an axial center of the outer shell.

These various embodiments and methods described herein enable the mass production of target fuel capsules for inertial confinement fusion (ICF) power plants, as well as enabling new designs for, and increasing the fabrication speed of, targets for ICF, HED, and fusion energy research. Additionally, various embodiments disclosed herein are expected to find utility in connection with the delivery of medicines and drugs which need to be encapsulated for use.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. As used herein, the term “about”, when used immediately previous to a specific recited value, denotes the specific recited value as well as all values, inclusive, from +/−10% of the specific recited value.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A target capsule apparatus for holding a fusion fuel, the apparatus comprising:
an additively manufactured outer shell having an inner surface and an interior area of the outer shell forming volume adapted to contain the fuel; and
the inner surface of the outer shell having a varying density which decreases in a radially inward direction towards an axial center of the outer shell.

2. The apparatus of claim 1, wherein the outer shell forms a solid outer shell.

3. The apparatus of claim 1, further comprising a tubular neck portion.

4. The apparatus of claim 1, wherein the inner surface of the outer shell comprises a foam structure.

5. The apparatus of claim 1, wherein the inner surface of the outer shell comprises a gyroid-like structure.

6. The apparatus of claim 1, wherein the inner surface of the outer shell comprises at least one of a membrane-based structure, a shell-based structure or a plate-based structure.

7. The apparatus of claim 1, wherein the inner surface of the outer shell comprises a lattice beam-like structure having at least one of a periodic construction or a stochastic construction.

8. The apparatus of claim 1, further including a neck portion extending from the outer shell, and further including an enlarged base connected to the neck portion.

9. The apparatus of claim 8, wherein:
the neck portion forms a tubular neck portion; and
the enlarged base includes:
an upper section attached to the neck portion;
a lower section having an extending fill tube, the fill tube having a length sufficient to extend into the tubular neck portion and into the interior area of the outer shell, and the fill tube being in communication with an interior area of the lower section; and
a plurality of mechanical elements configured to be readily broken when the lower section is rotated relative to the upper section, to enable removable of the fill tube from the tubular neck portion.

10. The apparatus of claim 1, wherein the outer shell forms a solid outer shell and is spherically shaped.

11. The apparatus of claim 1, wherein the outer shell forms a solid outer shell and is asymmetrically shaped.

12. The apparatus of claim 1, wherein the outer shell comprises an oblong shape.

13. The apparatus of claim 1, wherein the outer shell and the neck portion are formed from the same materials.

14. The apparatus of claim 1, further including a neck portion extending from the outer shell, and wherein at least one of:
the outer shell and the neck portion are formed from different materials; and
the outer shell and the inner surface are formed from different materials.

15. A target capsule apparatus for holding a fuel, the apparatus comprising:
an additively manufactured outer shell having an inner surface and an interior area of the outer shell forming interior volume adapted to contain the fuel;
the outer shell further including an opening formed therein;
a tubular portion projecting outwardly from the outer shell and communicating with the interior volume of the outer shell, and being integrally formed with the outer shell.

16. The apparatus of claim 15, wherein the tubular portion forms a tubular cone portion having a tip portion, and the tip portion projects into an interior area of the outer shell.

17. The apparatus of claim 15, wherein the tubular conical portion and the outer shell are integrally formed as a single, unitary structure from the same material.

18. The apparatus of claim 15, wherein the inner surface layer comprises one of:
a foam layer;
a gyroid-like layer;
a lattice beam-like layer;
a membrane-based structure;
a shell-based structure; or
a plate-based structure.

19. The apparatus of claim 15, wherein:
the tubular portion forms a tubular neck portion; and
wherein the apparatus further includes an enlarged base, with the enlarged base including:
an upper section attached to the tubular neck portion;
a lower section having an extending fill tube, the fill tube having a length sufficient to extend into the tubular neck portion and into the interior area of the outer shell, and the fill tube being in communication with an interior area of the lower section; and
a plurality of mechanical elements configured to be readily broken when the lower section is rotated relative to the upper section, to enable removable of the fill tube from the tubular neck portion.

20. A method for forming a target capsule apparatus for holding a fuel, the method comprising:
additively manufacturing:
an outer shell having an inner surface, with an interior area of the outer shell forming volume adapted to contain the fuel; and
a tubular neck portion integrally formed with the outer shell.

21. The method of claim 20, wherein the inner surface comprises at least one of:
a foam layer;
a gyroid layer; or
a lattice beam-like layer;
a membrane-based structure;
a shell-based structure; or
a plate-based structure.
